(19) United States
(12) Patent Application Publication
(10) Pub. No.: US 2012/0260776 A1
(43) Pub. Date: Oct. 18, 2012

(54) SOCKET AND HANDLE TOOL SET

(76) Inventor: Donald David Ridge, San Antonio, TX (US)

(21) Appl. No.: 13/087,195

(22) Filed: Apr. 14, 2011

(51) Int. Cl. B25B 23/00

(52) U.S. Cl. 81/57.29

(57) ABSTRACT

A socket and handle tool set facilitates the access of the socket to an obstructed fastener. Each socket provides a fastener receptacle to grip the fastener upon which the socket operates. Each socket splits open vertically along a vertical hinge. Specific embodiments provide a selectively latchable and unlatchable socket latch. Gear teeth are disposed around the circumference of at least a portion of the external perimeter of each socket. The gear teeth engage complimentary gear teeth that are disposed within the handle of the handle component of the tool set. The handle provides a socket holder and a socket drive mechanism disposed in the socket holder to engage the gear teeth of the socket. Additionally, the handle component of the tool set provides a driver tool receptacle distal from the socket handle to receive a driver tool to operate the socket drive mechanism.

### TECHNICAL FIELD

This disclosure relates generally to mechanical tools and more particularly to a tool set having a socket handle and one or more selectively vertically openable socket operable by the handle.

### BACKGROUND

It is not unusual when working with fasteners such as nuts and bolts and pipe fittings that one encounters a fastener that is obstructed to access with a tool such as a socket wrench. In such circumstances, an open-faced wrenched may not be suitable because the working space is too restricted to allow the wrench to pivot effectively, or for the wrench to be reset for the next pivot. A ratcheting socket-type wrench, which could pivot if the socket could be fitted over the fastener, may not be suitable because the working space is too confined to get the socket over the fastener, or to get the wrench attached to the socket.

A number of possible solutions have been proposed for this problem, many involving a selectively openable socket that can open and closed with a hinge. See for example U.S. Pat. No. 2,522,428, disclosing a hinged socket; U.S. Pat. No. 2,656,750, disclosing a wrench with hinged wrench head; U.S. Pat. No. 3,008,363, disclosing a hinged socket and ratchet handle; U.S. Pat. No. 4,262,561 disclosing an shaft-driven internally geared wrench handle and socket head; U.S. Pat. No. 5,131,300, disclosing a hinged socket; and U.S. Pat. No. 6,799,492, disclosing a hinged wrench head.

Nevertheless, it would be useful in some circumstances to have a hinged socket with external gear teeth such that the socket can be selectively opened and closed to be seated around or over an obstructed fastener. A geared socket handle is attached to the socket so the gear teeth of the handle engage the external teeth of the socket. The handle, in turn, is selectively attachable to an actuator of driver tool, such as a ratchet wrench, which remotely drives the handle gears.

### SUMMARY

A socket and handle tool set is provided to facilitate the access of the socket to an obstructed nut bolt, for example, or some other fastener for which the socket is adapted to grip. A kit of the present tool set provides a plurality of sockets of varying sizes and having fastener receptacles in a variety of shapes and sizes to accommodate fasteners of different sizes and shapes that an operator might encounter on the job. Additionally, specific embodiments of a kit provide handles of varying length and socket receptacles in variety of shapes and sizes.

Each socket provides a fastener receptacle to grip the fastener upon which the socket operates. Each socket splits open vertically along a vertical hinge. Specific embodiments provide a selectively latchable and unlatchable socket latch distal from the hinge to secure the socket in a closed position when the socket is disposed around a fastener.

Gear teeth are disposed around the circumference of at least a portion of the external perimeter of each socket. The gear teeth engage complimentary gear teeth that are disposed within the handle body of the handle component of the tool set.

The handle provides a socket holder portion and a socket drive mechanism disposed in the socket holder to engage the gear teeth of the socket. The socket drive mechanism in the handle is, for example, a gear assembly connected to a drive shaft in the handle and that engages the gear teeth around the external circumference of the socket. Alternative embodiments of a handle of the present disclosure provide a plurality of socket holders and/or driver tool receptacles.

Additionally, the handle component of the tool set provides a tool receptacle distal from the socket holder to receive a driver tool to operate the socket drive mechanism. The driver tool is any tool such as a wrench, ratchet wrench, or drill that can turn the drive rod in the handle, which turn the socket drive mechanism, which turns the socket which turns the fastener that is the object upon which the socket operates. The driver tool may be manual or motorized, either electrically or pneumatically, for example.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an isometric top distal view of an exemplary embodiment of a tool handle of the present disclosure.

FIG. 2 is an isometric top proximal view of an exemplary embodiment of a tool handle of a tool of the present disclosure.

FIG. 3 is an isometric truncated top view of an exemplary embodiment of a socket tool of the present disclosure.

FIG. 3A is an isometric truncated top view of an exemplary embodiment of a socket disposed within a tool handle of the present disclosure.

FIG. 4 is an isometric bottom view of an exemplary embodiment of the socket of FIGS. 3 and 3A.

FIG. 5 is a top view of an exemplary embodiment of a closed socket tool of the present disclosure.

FIG. 6 is a top view of an exemplary embodiment of an open socket tool of the present disclosure.

FIG. 7 is a top view of an exemplary embodiment of a tool handle of the present disclosure.

FIG. 8 is a side cross-sectional view of an exemplary embodiment of a tool handle of the present disclosure.

FIG. 9 is an isometric detail of the gear assembly of the tool handle of FIG. 8.

FIG. 10 is a side cross-sectional view of an alternative exemplary embodiment of a tool handle of the present disclosure.

FIG. 11 is an isometric detail of the gear assembly of the tool handle of FIG. 10.

FIG. 12 is a isometric diagrammatic operational illustration of an exemplary embodiment of a tool of the present disclosure.

FIG. 13 is a isometric diagrammatic operational illustration of an exemplary alternative embodiment of a tool of the present disclosure.

### DETAILED DESCRIPTION

Securing a socket around a fastener that has obstructed access can be a challenge. Described herein is a socket and handle set to facilitate operations on an obstructed fastener. The socket is selectively openable and closeable by means of a hinge. A row of gear teeth is disposed around the external, top, perimeter of the socket. The gear teeth engage a gear assembly mounted in the handle. The handle has a socket receptacle to receive the socket. The socket receptacle provides an aperture through which the internal gear assembly is exposed to and is able to engage the gear teeth of the socket. At the end of the handle distal to the socket receptacle, the handle provides a tool port which receives a tool such a ratchet wrench. The tool engages the handle's internal gear assembly via a drive shaft, for example, to impart a rotational motion to the socket.

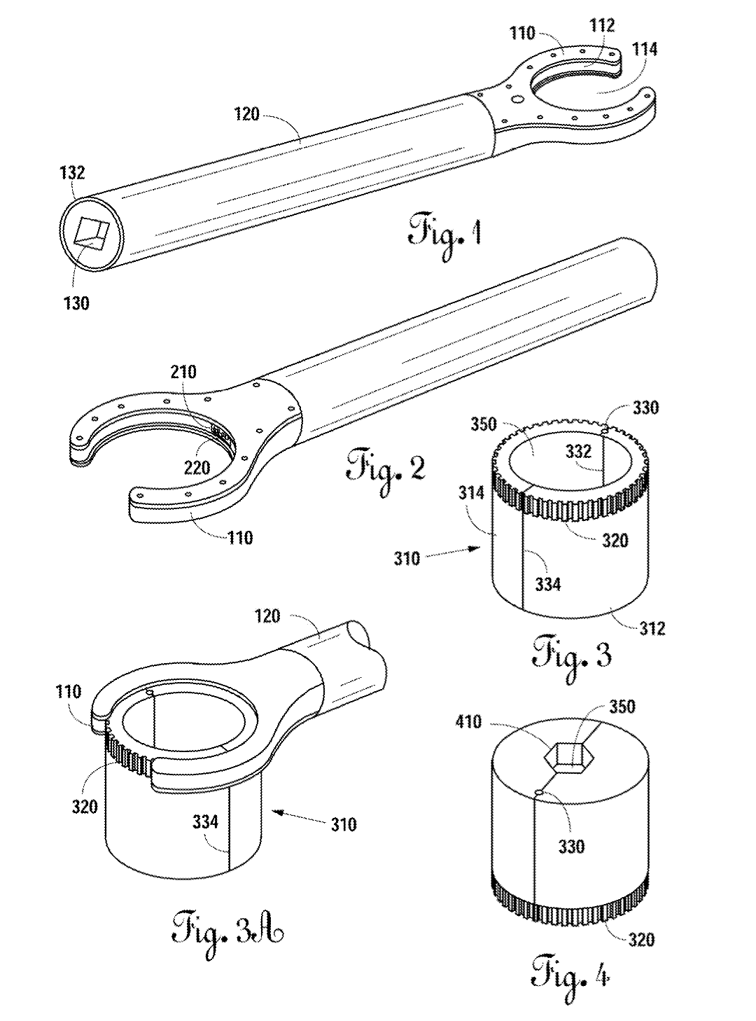

Referring to FIG. 1 of the drawings, FIG. 1 is an isometric top distal view of an exemplary embodiment of a tool handle of the present disclosure. Socket end 110 of handle 120 provides socket receptacle 114. Groove or track 112 circumscribes the interior surface of receptacle 114. Tool or actuator receptacle 130 at distal end 132 receives an actuator such as a ratchet wrench, for example.

FIG. 2 is an isometric top proximal view of an exemplary embodiment of a tool handle of the present disclosure. Socket end 110 provides aperture 210 through which gears 220 are exposed.

FIG. 3 is an isometric truncated top view of an exemplary embodiment of a socket tool of the present disclosure. Socket 310 has external teeth circumscribing the external perimeter the socket. A vertical hinge 330 extends from top to bottom along seam 332. A corresponding selectively openable and closeable seam 334 is across the socket from seam 332. Seams 332 and 334 cooperate to form complementary halves 3212 and 314 of socket 310. Bore 350 extends the length of socket 310 to receive a fastener with a friction fit.

FIG. 3A is an isometric truncated top view of an exemplary embodiment of a socket tool disposed within a tool handle the present disclosure. External gear teeth 320 are seated in track or groove 112. Specific preferred embodiments provide external gear teeth 320 such the top of the gear ridges are substantially flush with the external surface of socket 310. Alternative embodiments provides gear teeth 320 with ridges that are not flush. For example, the ridges project outward slightly and in such alternative embodiments track 112 is more of a groove that is slightly deeper than in the embodiments for flush gear teeth such that groove 112 retains gear teeth 320 relatively more securely.

FIG. 4 is an isometric bottom view of an exemplary embodiment of the socket tool of FIGS. 3A and 3B. Bore 350 terminates at the bottom of socket 310 at hex aperture 410, which may be selectively disposed around a fastener such as a hex nut or a hex-topped bolt. Of course, sockets with fastener receptacles for all manner of fasteners are contemplated.

FIG. 5 is a top view of exemplary alternative embodiments of a closed socket tool of the present disclosure. The ridges 530 of gear teeth 320 are flush with external surface 540 of socket 310. Hex fitting 410 (small size) or 510 alternative embodiment large size) is seen by looking down through bore 350. Latch 520 is formed in seam 334.

FIG. 6 is a top view of an exemplary embodiment of an open socket tool of the present disclosure. Latch clasp 522 mates with clasp receptacle 524 for form latch 520. Socket 310 is opened by pivoting halves 312/314 around hinge 330.

FIG. 7 is a top truncated view of an exemplary embodiment of a tool handle of the present disclosure. Handle gear teeth 220 protrude outward into track 112.

FIG. 8 is a side truncated cross-sectional view of an exemplary embodiment of a tool handle of the present disclosure. Actuator receptacle 130 engages 820 drive shaft 830 disposed within handle cavity 810. Drive shaft 830 terminates at the socket holder end of the handle with vertical drive shaft gear head 840. Fixed bearing collar 850 supports drive shaft 830 and facilitates the alignment of drive shaft gear head 840 with socket driver actuating gear 842. Socket driver gear head 844 is engaged by socket driver actuating gear 842 and is turned in a rotational manner around gear assembly axel 860 upon rotational actuation by a driver tool (not shown) attached at 130. Horizontal lower gear structure 844 is arranged so that a portion of its gear teeth 220 protrude through aperture 210. Gear structures 840, 842, 844 and 860 may be referred to herein from time to time collectively as the gear assembly.

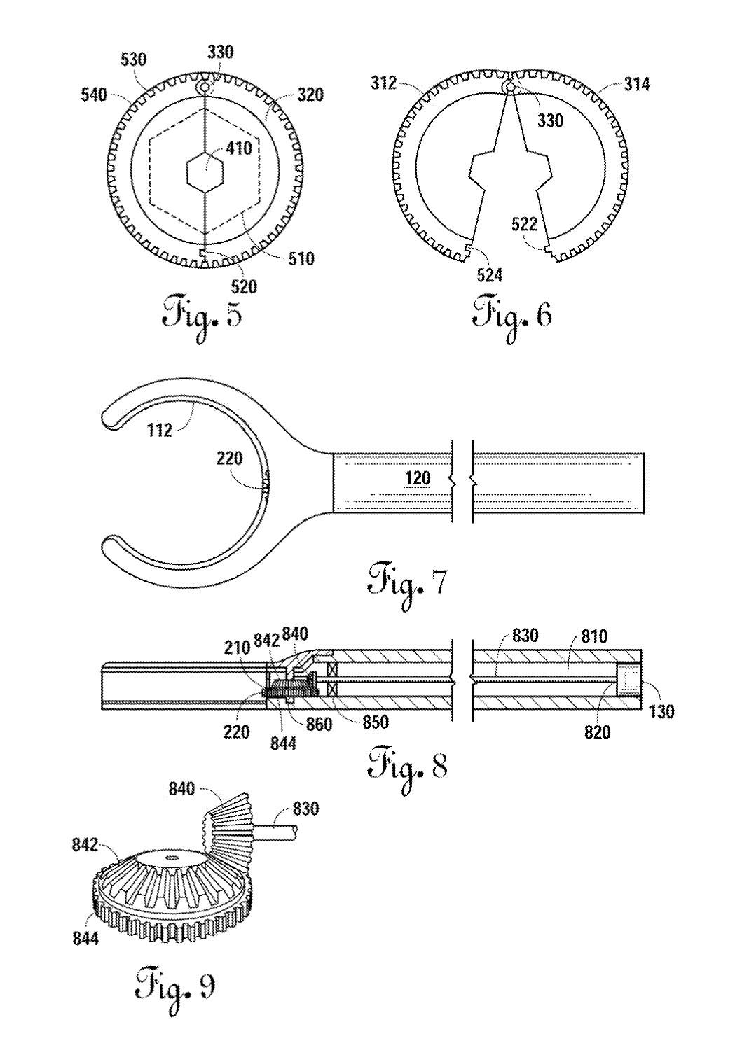

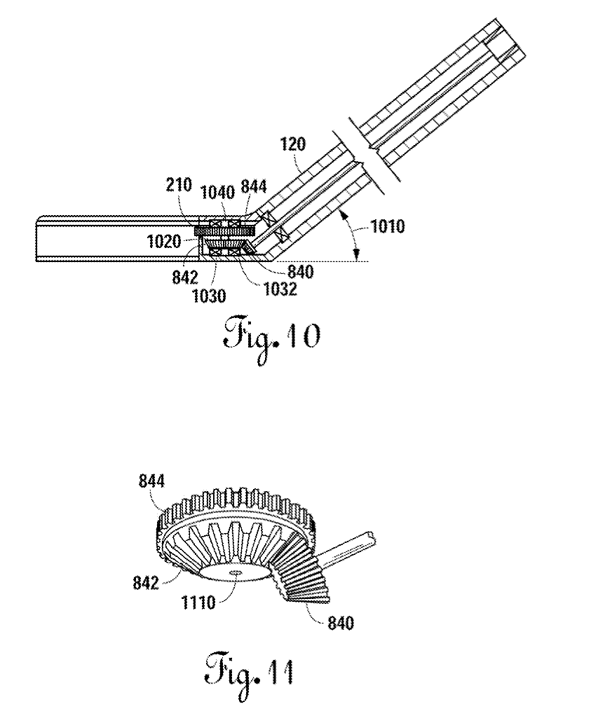

FIG. 9 is an isometric detail of the gear assembly of the tool handle of FIG. 8. The gear teeth of drive shaft gear head 840 are presented in this embodiment at an acute angle from an imaginary horizontal plane and the gear teeth of socket driver actuating gear 842 are correspondingly angled to matingly engage the teeth of head 840. In contrast, the gear teeth of horizontal lower structure 844 are substantially normal (perpendicular) to the horizontal plane to matingly engage the external gear teeth 320 of socket 310.

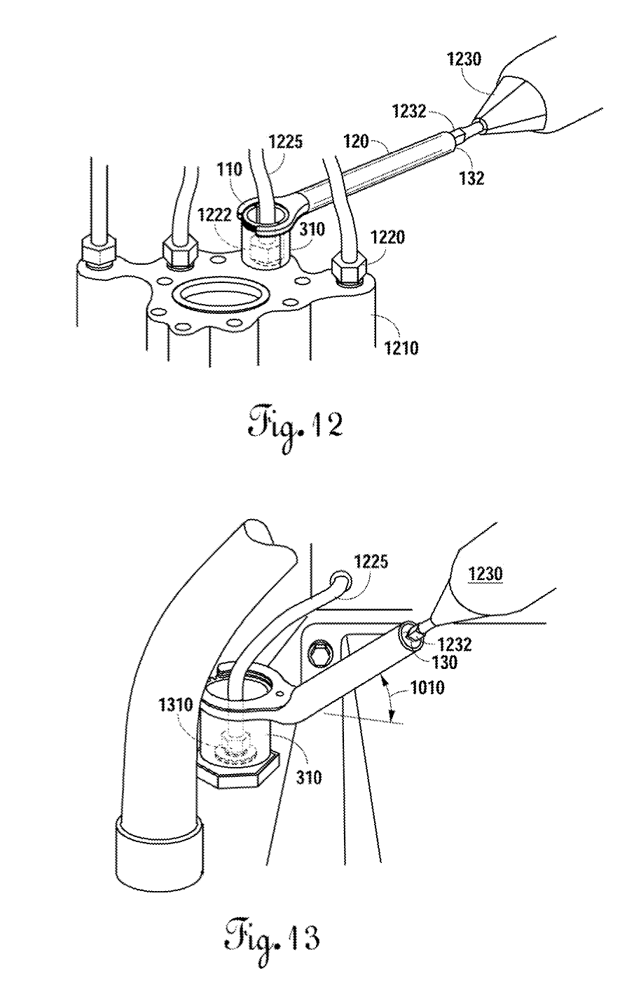

FIG. 10 is a side cross-sectional view of an alternative exemplary embodiment of a tool handle of the present disclosure. In contrast to the embodiment of FIG. 8, where the socket holder portion 110 and the handle body portion 120 are co-linear, the handle body 120 of the exemplary embodiment of FIG. 10 forms an acute angle 1010 in relation to the socket holder and the acute angle's supplementary obtuse angle. To accommodate this geometry, gear head 840 engages socket driver actuating gear 842. Spacer bearings 1030 and 1032 align gear 842 with gear head 840. Axel 1040 is actuated by gear 842 and rotates gear 844 when actuated by a tool (not shown) attached distally. Gear teeth 210 protrude from the aperture in track 1020 to engage socket 310 (not shown).

FIG. 11 is an isometric detail of the gear assembly of the tool handle of FIG. 10.

FIG. 12 is a isometric diagrammatic operational illustration of an exemplary embodiment of a tool of the present disclosure. On a mechanical block 1210, various lines 1225 lead in and out and are fastened to the block with nut fasteners 1220, 1222. The lines 1225 prevent a socket from being slipped over nut 1222, for example, to loosen or tighten nut 1225. A socket 310, however, can be opened as shown in FIG. 6 and placed around nut 1222 and latched closed as shown in FIG. 5. Socket handle 120 is attached to socket 310 with receptacle 110 such that the gear teeth are engaged. A driver tool 1230, such as a ratchet wrench or a drill, for example, is connected to handle 120 at distal end 132 such that tool bit 1232 engages drive shaft 330 (not visible) through port 130 (not visible in this view) to turn drive shaft 830. The driver tool is selected by an operator based on the task to be performed and may be manual or motorized with an electric or pneumatic motor, for example.

FIG. 13 is an isometric diagrammatic operational illustration of an exemplary alternative embodiment of a tool of the present disclosure. Similar to operational arrangement and method described above for FIG. 12, FIG. 13 depicts an obstructed nut 1310 accessed with the angled handle embodiment of FIG. 10. From this view, driver tool 1230 can be seen inserted into tool port 130 with tool bit 1332.

Many modifications and other embodiments of the socket and handle described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A socket and handle tool set, the set comprising:
one or more vertically hinged sockets having an external perimeter, one or more of the sockets further comprising gear teeth around at least a portion of the external perimeter; and
one or more socket handles having at least one socket holder, wherein at least one of the handles further comprises:
a socket drive assembly disposed in the socket holder to engage the gear teeth of one or more of the sockets, and
a tool receptacle distal from the socket handle to receive a driver tool to operate the socket drive assembly.

2. The socket and handle tool set of claim 1, wherein one of the sockets further comprises a latch.

3. The socket and handle tool set of claim 1, wherein the socket drive assembly of one of the handles comprises a drive shaft connected to a gear assembly.

4. The socket and handle tool set of claim 3, wherein the socket holder of one of the handles provides an aperture through which the gear assembly of the socket drive assembly is able to engage the gear teeth of one of the sockets.

5. The socket and handle tool set of claim 1, wherein one of the handles comprises a socket holder portion and a handle body portion and further wherein the socket holder and the handle body portion are co-linear.

6. The socket and handle tool set of claim 5, wherein the handle portion forms an obtuse angle with the socket holder portion.

7. The socket and handle tool set of claim 1, wherein the ridges of the gear teeth of one of the sockets are flush with external perimeter.

8. The socket and handle tool set of claim 1, wherein the ridges of the gear teeth of one of the sockets are not flush with the external perimeter.

9. A socket and handle tool set, the set comprising:
one more vertically hinged sockets having an external perimeter, one or more of the sockets further comprising gear teeth around the external circumference of at least a portion of the external perimeter;
one or more socket handles having at least one socket holder, the socket holder having an aperture to receive a socket drive gear therethrough, wherein at least one of the handles further comprises:
a socket holder portion and a handle body portion;
an internal longitudinal bore in the handle body portion having a drive shaft disposed therein, a gear assembly connected to the drive shaft, the gear assembly further comprising a socket drive gear such that the socket drive gear is disposed in the socket holder aperture to engage the external gear teeth of one of the sockets through the aperture, and
a tool receptacle distal from the socket holder to receive a driver tool such that the driver tool actuates the drive shaft connected to the socket drive gear.

10. The socket and handle tool set of claim 9, wherein the socket holder and the handle body portion of one of the handles are co-linear.

11. The socket and handle tool set of claim 9, wherein the handle portion of one of the handles forms an obtuse angle with the socket holder portion.

12. The socket and handle tool set of claim 9, wherein the ridges of the gear teeth of one of the sockets are flush with external perimeter.

13. The socket and handle tool set of claim 9, wherein the ridges of the gear teeth of one of the sockets are not flush with external perimeter.

14. The socket and handle tool set of claim 9, wherein one of the sockets further comprises a latch.

15. A socket for use with an actuator, the socket comprising external gear teeth to matingly engage with gear teeth of a drive mechanism connectable to the actuator.

16. The socket and handle tool set of claim 15, wherein the socket further comprises a vertical hinge.

17. The socket and handle tool set of claim 16, wherein the socket further comprises a latch distal from the hinge.

18. The socket and handle tool set of claim 15, wherein the socket further comprises a vertical hinge and a latch distal from the hinge.
